(19) United States
(12) Patent Application Publication
(10) Pub. No.: US 2023/0373527 A1
(43) Pub. Date: Nov. 23, 2023

(54) METHOD AND DEVICE FOR ADJUSTING A PLANNED TRAJECTORY FOR A VEHICLE

(71) Applicant: ZF Friedrichshafen AG, Friedrichshafen (DE)

(72) Inventors: Eckehard Münch, Bünde (DE); Stephan Pollmeyer, Friedrichshafen (DE); Katharina Hansen, Hilter a. T.W. (DE)

(73) Assignee: ZF Friedrichshafen AG, Friedrichshafen (DE)

(21) Appl. No.: 18/248,464

(22) PCT Filed: Sep. 28, 2021
(86) PCT No.: PCT/EP2021/076588

§ 371 Date: Apr. 10, 2023

(30) Foreign Application Priority Data
Oct. 29, 2020 (DE) 10 2020 213 604.1

(51) Int. Cl. B60W 60/00; B60W 40/068; B60W 40/107; B60W 40/109

(52) U.S. Cl. CPC B60W 60/0015; B60W 40/068; B60W 40/107; B60W 40/109; B60W 2520/105; B60W 2520/125; B60W 2552/40

(57) ABSTRACT

A method for adjusting a planned trajectory of a vehicle, such as a vehicle for highly automated driving. A plurality of different limit data sets are produced for implementing the planned trajectory using at least one drive-dynamical characteristic value of the vehicle and an estimated value for a friction coefficient between the vehicle and a road. Each limit data set contains limit values for a kinematic driving condition of the vehicle. A data set having the lowest limit values with which the planned trajectory can be implemented is selected from the limit data sets produced. The planned trajectory is calculated as a function of current trajectory control data and as a function of the selected limit data set, where the trajectory control data comprise current environment data from an environment sensor of the vehicle and/or current position data from a position sensor of the vehicle. The planned trajectory is adjusted.

### RELATED APPLICATIONS

This application claims the benefit under 35 U.S.C. § 371 as a U.S. National Phase Application of application no. PCT/EP2021/076588, filed on 28 Sep. 2021, which claims the benefit of German Patent Application no. 10 2020 213 604.1, filed 29 Oct. 2020, the contents of which are hereby incorporated herein by reference in their entireties.

### FIELD OF THE DISCLOSURE

The present invention relates to a method for adjusting a planned trajectory for a vehicle, to a corresponding device, and to a vehicle having such a device.

### BACKGROUND

Drive-dynamical limits of a vehicle can affect a trajectory that can be planned for a vehicle. Furthermore, unforeseen events can occur that can influence the driving of the vehicle along a planned trajectory. DE 10 2018 203 617 A1 discloses a method for calculating a trajectory limitation and a method for regulating a drive dynamic.

### SUMMARY

Against that background the present invention provides an improved method for adjusting a planned trajectory for a vehicle, an improved device for adjusting a planned trajectory for a vehicle, and an improved vehicle. Advantageous design features will be apparent from the description that follows.

According to embodiments, a planned trajectory for a vehicle can be set with several fallback levels as regards the use of drive-dynamical constraints of the vehicle. To put it differently, according to embodiments, for example, multi-stage fallback levels can be provided for validating a trajectory plan for a vehicle, particularly a vehicle for highly automated driving. Advantageously, according to embodiments, particularly in that way a large number of driving situations can be validated by the use of drive-dynamical constraints, so that fewer driving situations with unknown outcomes remain. Thus, a trajectory can be planned securely and reliably in such manner that even if unforeseen events occur, drive-dynamical reserves remain which can be used.

A method for setting a planned trajectory for a vehicle, in particular a vehicle for highly automated driving, comprises the following steps:
production of a number of different limit data sets for implementing the planned trajectory, using at least one drive-dynamical characteristic value of the vehicle and an estimated value for a friction coefficient between the vehicle and a road, wherein each limit data set comprises limit values for a kinematic driving condition of the vehicle;
calculation of the planned trajectory, as a function of current trajectory control data and as a function of a selected limit data set from among the number of limit data sets produced, wherein the limit data set with the lowest limit values is selected, with which the planned trajectory can be implemented, wherein the trajectory control data comprise current environment data from an environment sensor of the vehicle and/or current position data from a position sensor of the vehicle; and
adjusting the planned trajectory.

This method can be implemented for example in the form of software or hardware, or in a mixed form combining software and hardware, for example, in a device or a control unit. The vehicle can be a motor vehicle, in particular a land vehicle such as a passenger car a bus, a truck, or some other utility vehicle. The planned trajectory can or will be provided by a trajectory planning device of the vehicle. The at least one drive-dynamical characteristic value can be represented by a physical magnitude, a steering system, a drive unit, a brake, a tire, a chassis, or a vehicle body, such as an available drive torque, a steering angle that can be set, a steering torque that can be obtained, a design of the axle kinematics, a steering gear ratio, a transmission gear ratio, a vehicle mass, a vehicle geometry, or the like. The kinematic condition can be represented by an acceleration, a speed, a curvature, a curvature change, an acceleration change rate, a yaw rate, a yaw rate change, and/or the like. The at least one environment sensor can comprise a vehicle camera, a radar unit, a lidar unit, or the like for registering an environment of the vehicle. The current position data can represent a current position of the vehicle relative to a geographical reference system. The selection step can be carried out using, or in the context of, a planning algorithm or a trajectory planning device. Thus, by way of defined interfaces several limits with different safety aspects, such as degraded steering, fully operational steering and the like, can be made available to the planner or the trajectory planning device.

According to an embodiment, in the production step the limit data sets can be produced using various safety factors for scaling the at least one drive-dynamical characteristic value, and additionally or alternatively the estimated value for the friction coefficient. In this case the safety factors can be defined at least as a function of an estimated, measured or otherwise known error magnitude, for example notified by the actuator, of a stochastic uncertainty, and additionally or alternatively, of a measured or estimated wear condition of at least one actuator of the vehicle. More precisely, the at least one drive-dynamical characteristic value or characteristic values and in addition or alternatively the friction coefficient of each limit data set can be multiplied by one or more safety factors. A safety factor can be, for example, a number between 0 and 1, a negative number, or a positive number greater than 1. Such an embodiment has the advantage that by virtue of limit data sets scaled in that manner, depending on the current driving situation, a safety reserve in relation to the drive dynamics can be kept available, which in case of need can be used to the full extent in order to manage various critical driving situations. It is possible to work with known, measured, or if necessary, conservatively estimated physical parameters, such as a maximum steering angle, for example, in the event of a degradation.

In particular, in the production step a first limit data set with first limit values can be produced using a first estimated value for the frictional coefficient, and at least a second limit data set with second limit values can be produced using a second estimated value for the friction coefficient, wherein physical limiting values based on a third estimated value for the friction coefficient apply. In this case the second estimated value can be larger than the first estimated value and smaller than the third estimated value. Then the second limit values can be larger than the first limit values and smaller than the physical limit values. The limit data sets can also be produced using differently scaled drive-dynamical characteristic values. The second estimated value for the friction coefficient can represent a realistic estimate, whereas the first estimated value can be a cautious or conservative estimate, while the third estimated value can represent a predefined maximum or infinitely large friction coefficient. Such an embodiment has the advantage that, depending on the driving situation, and according to need, as a first step a validation of planned trajectories having regard to uncertainties, as a second step the tackling of suddenly occurring events with more severe drive-dynamical demands, or as a third step the utilization of a full drive-dynamical potential can be achieved, if the two previous steps do not provide an accident-free trajectory, in which possible damage reduction is also enabled.

According to an embodiment, in the production step, for each limit data set using the at least one drive-dynamical characteristic value and the estimated value for the friction coefficient, a value field is determined in an acceleration diagram relating to the longitudinal acceleration and the transverse acceleration of the vehicle. The acceleration diagram can be a so-termed G-G diagram. In this case the value field can be approximated and described by polygons. Such an embodiment has the advantage that the limit data sets can be related to a uniform and clear reference, whereby a simple, precise and reliable scaling of the limit values for various fallback levels can be enabled. The method can also comprise a step of reading the at least one drive-dynamical characteristic value, the environmental data, and in addition or alternatively, the position data. The environmental data can be provided by an environment sensor of the vehicle. The position data can be provided by a position sensor and in addition or alternatively a satellite receiver unit of the vehicle. The at least one drive-dynamical characteristic can be read from a storage device. Such an embodiment has the advantage that the input data required for carrying out the method can be made available in a simple and reliable manner.

In addition, the method can comprise a step of estimating the friction coefficient, using the environment data and in addition or alternatively the position data. In addition, or alternatively, in the estimation step the friction coefficient can also be read out, selected or retrieved from a list or table with estimated friction coefficients, optionally as a function of the environment data and in addition or alternatively the position data. Such an embodiment has the advantage that only the friction coefficient needs to be estimated, since the drive-dynamical characteristic value of the vehicle is present in any case. Thus, the various limit data sets can be produced in a simple manner.

The approach presented here also provides a device which is designed to carry out, control or implement the steps of a variant of a method presented here with corresponding devices. In this embodiment variant of the invention in the form of a device as well, the objective on which the invention is based can be achieved quickly and efficiently.

Thus, the steps of the method can be implemented in a suitable device, which can be part of a control unit of the vehicle, such as an embodiment of the above-mentioned device. A device can be an electrical unit which processes electric signals, for example, sensor signals, and emits control signals as a function of the electric signals. The device can have one or more suitable interfaces of hardware and/or software design. In the case of a hardware design the interfaces can for example be part of an integrated circuit in which functions of the device are carried out. The interfaces can also be separate integrated circuits, or at least can consist of discrete structural elements. In the case of a software design the interfaces can be software modules, for example, present in a microcontroller in addition to other software modules.

Also advantageous is a computer program product with program codes which can be stored on a machine-readable support such as a semiconductor memory, a hard disk memory or an optical memory and can be used for carrying out the method in accordance with one of the embodiment described above, when the program is run on a computer or a device.

A corresponding vehicle, in particular a vehicle for highly automated driving, comprises an embodiment of the above-described device for implementing a planned trajectory of the vehicle.

### BRIEF DESCRIPTION OF THE DRAWINGS

An example of the invention is now described in greater detail with reference to the attached drawings, which show:

FIG. 1: A schematic representation of a vehicle with a device according to an example embodiment;

FIG. 2: A schematic acceleration diagram for a vehicle, according to an example embodiment;

FIG. 3: A schematic drive-power/speed diagram for various transmission stages of a vehicle, according to an example embodiment;

FIG. 4: A schematic acceleration diagram for a vehicle, according to an example embodiment;

FIG. 5: A schematic acceleration diagram for a vehicle, according to an example embodiment;

FIG. 6: A flow chart of a method for adjustment, according to an example embodiment; and

FIG. 7: A schematic representation of a device, according to an example embodiment.

In the following description of preferred example embodiments of the present invention, the same or similar indexes are used for elements with a similar function shown in the various figures, so that repeated descriptions of the said elements are not necessary.

### DETAILED DESCRIPTION

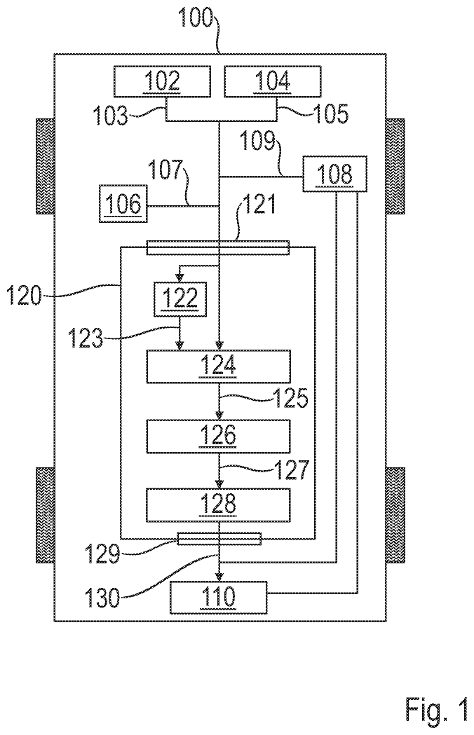

FIG. 1 shows a schematic representation of a vehicle 100 with a device 120 according to an example embodiment. The vehicle 100 is in particular designed for highly automated driving. The vehicle 100 is a motor vehicle, in particular a land vehicle, such as a passenger car, a bus, a truck, or some other utility vehicle. The vehicle 100 contains the device 120 for adjusting a planned trajectory for the vehicle 100. Thus, the device 120 is designed to adjust a planned trajectory for the vehicle 100.

According to the example embodiment shown in this case, the vehicle 100 also comprises an environment sensor 102, a position sensor 104, a storage device 106, a trajectory planning device 108, and at least one actuator 110. The environment sensor 102 is designed to register an environment of the vehicle 100 and to provide environmental data 103 that represent the environment detected. The environment sensor 102 can be, for example, a vehicle camera, a radar unit, or the like. By means of the environment sensor 102, for example, obstacles in the surroundings of the vehicle 100 can be recognized. The position sensor 104 is designed to register a geographical position of the vehicle 100 and to provide position data that represent the position detected. The position sensor 104 can be, for example, a satellite receiver or the like. The storage device 106 is designed to store at least one drive-dynamical datum 107 that represents a drive-dynamical characteristic value of the vehicle 100 for the device 120, in such manner that it can be retrieved or read, the trajectory planning device 108 is designed to plan a trajectory for the vehicle 100 and to provide trajectory data 109 that represent the planned trajectory. The actuator 110 is designed to implement the planned trajectory and for that purpose to carry out appropriate control interventions in the vehicle's processes relating to chassis, transmission, steering, braking and the like.

The device 120 is connected for the exchange of signals with the environment sensor 102, the position sensor 104, the storage unit 106, and the trajectory planning device 108. Otherwise than as represented, the device 120 can also be made as part of the trajectory planning device 108 and/or the device 120 can also include the storage device 106. The actuator 110 is connected for the exchange of signals with the trajectory planning device 108 and/or the device 120. The device 120 contains a production device 124, a selection device 126 and an application device 128. Furthermore, in the example embodiment shown in this case the device 120 also includes an input interface 121, an estimating device 122 and an output interface 129.

In the example embodiment shown here the device 120 is designed to read in the environment data 103, the position data 105 and the drive-dynamical data 107 by way of the input interface 121. Further, the device 120 in the example embodiment shown here comprises the estimating device 122. The estimating device 122 is designed to estimate a friction coefficient of a frictional contact between the vehicle 100 and a road, using the environment data 103 and/or the position data 105. Thus, the estimating device 122 is designed, using the environment data 103 and/or the position data 105, to provide an estimated value 123 for the frictional coefficient.

The production device 124 is designed, using the at least one drive-dynamical characteristic value of the vehicle 100 from the drive-dynamical data 107 and using the estimated value 12 for the friction coefficient, to produce a plurality of different limit data sets 125 for implementing the planned trajectory. Each limit data set 125 produced by the production device 124 contains limit values for a kinematic driving condition of the vehicle 100, for example an acceleration, in particular relating to a longitudinal axis and a transverse axis of the vehicle 100.

According to an example embodiment, the production device 124 is designed to produce the limit data sets 125 using various safety factors for scaling the at least one drive-dynamical characteristic value and/or the estimated value 123 for the friction coefficient. In this case the safety factors are defined at least as a function of an estimated, measured or otherwise known error magnitude, for example, communicated by the actuator, or a stochastic uncertainty, and/or a measured or estimated wear condition of the at least one actuator 110 of the vehicle. In particular the production device 124 is designed, using a first estimated value 123 for the friction coefficient, to produce a first limit data set 125 with first limit values, and using a second estimated value 123 for the friction coefficient, to produce at least a second limit data set 125 with second limit values, wherein physical limit values on the basis of a third estimated value 123 for the friction coefficient apply. In this case the second estimated value 123 is larger than the first estimated value 123 and smaller than the third estimated value 123. Furthermore, the second limit values are larger than the first limit values and smaller than the physical limit values. According to an example embodiment, the production device 124 is designed, for each of the limit data sets 125 using the at least one drive-dynamical characteristic value from the drive-dynamical data 107 and the estimated value 123 for the friction coefficient and information from the actuator or actuators, for example, the maximum steering torque, to determine a value field in an acceleration diagram related to the longitudinal and transverse accelerations of the vehicle 100. In particular, as regards the example embodiments mentioned here more detailed explanations will be given with reference to the figures below.

The selection device 126 is designed, as a function of current trajectory control data, in this case current environment data 103 and current position data 105, to select from the plurality of limit data sets produced that limit data set 127 which has the lowest limit values by means of which the planned trajectory can be implemented as a function of current trajectory control data. Stated differently, the selection device 126 is designed to provide a limit data set 127 selected from among the plurality of limit data sets 125 in accordance with selection criteria. As such, the selection criteria include both minimal limit values for the kinematic driving condition and also a transformability of the planned trajectory against the background of the trajectory control data. According to the example embodiment represented here, the trajectory control data include the current environment data 103 and the current position data 105. According to another example embodiment, the trajectory control data include the current environment data 103 or the current position data 105.

According to the example embodiment shown here, the application device 128 is designed to use the selected limit data set 127 on the trajectory planned from the trajectory data 109 in order to adjust the trajectory or to provide an adjusted trajectory in the form of a control signal 130. Otherwise expressed, the application device 128 is designed, using the selected limit data set 127, to produce the control signal 130 that represents the adjusted trajectory.

According to an example embodiment, the two or more calculated limit data sets 125 are communicated to the trajectory planning device 108. The latter then adjusts a trajectory having regard to the limits. Thus, the result complies with the said limits. The decision which limits are to be used therefore falls to the planning algorithm or the trajectory planning device 108. In this case the selection device 126 and the application device 128 are integrated or combined with the trajectory planning device 108.

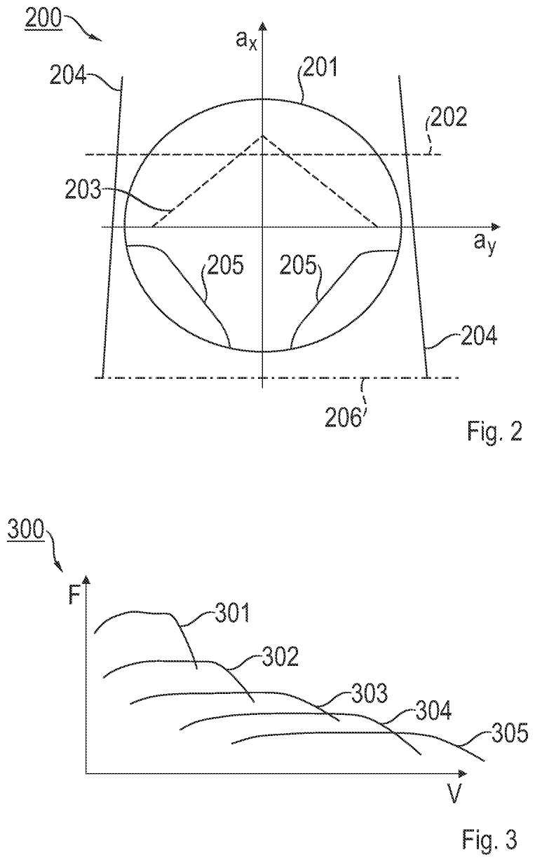

FIG. 2 shows a schematic acceleration diagram 200 for a vehicle, in accordance with an example embodiment. The acceleration diagram 200 relates, for example, to the vehicle in FIG. 1 or to another or a similar vehicle. Plotted along an abscissa of the acceleration diagram 200 is an acceleration aₓ along a longitudinal axis x of the vehicle. Plotted on an ordinate axis of the acceleration diagram 200 is an acceleration a_{y} along a transverse axis y of the vehicle.

In the acceleration diagram 200, only as examples, in a friction circle 201 centered at the origin of the acceleration diagram 200 is indicated a friction-related acceleration limit at the vehicle level, a drive unit limit 202 for the acceleration arising from speed-dependent constraints of the drive unit and drive-train, a slip limit 203 relating to the inside wheel (differential), tilt limits 204 for the tipping over the vehicle, ABS limits 205 resulting from the intervention of anti-block system functions, and a braking limit 206 resulting from general limitations of the braking system. The friction circle 201 scales with the friction coefficient μ. The centering at the origin represents a journey on absolutely flat ground. If the road slopes upward or downward, then the diagram shifts away from the origin.

FIG. 3 shows a schematic drive-power/speed diagram 300 for various transmission gears of a vehicle, according to an example embodiment. A speed v of the vehicle is plotted along the abscissa of the driving-force/speed diagram 300. A drive power F of the vehicle is plotted on the ordinate of the driving-force/speed diagram 300. The drive-power/speed diagram 300 is related to the drive limits in FIG. 2. In the drive-power/speed diagram 300 a first graph 301 is shown, which represents a variation of drive power F against the speed v for a first gear or transmission stage, a second graph 302 which represents a variation of drive power F against the speed v for a second gear or transmission stage, a third graph 303 which represents a variation of drive power F against the speed v for a third gear or transmission stage, a fourth graph 304 which represents a variation of drive power F against the speed v for a fourth gear or transmission stage, and a fifth graph which represents a variation of drive power F against the speed v for a fifth gear or transmission stage.

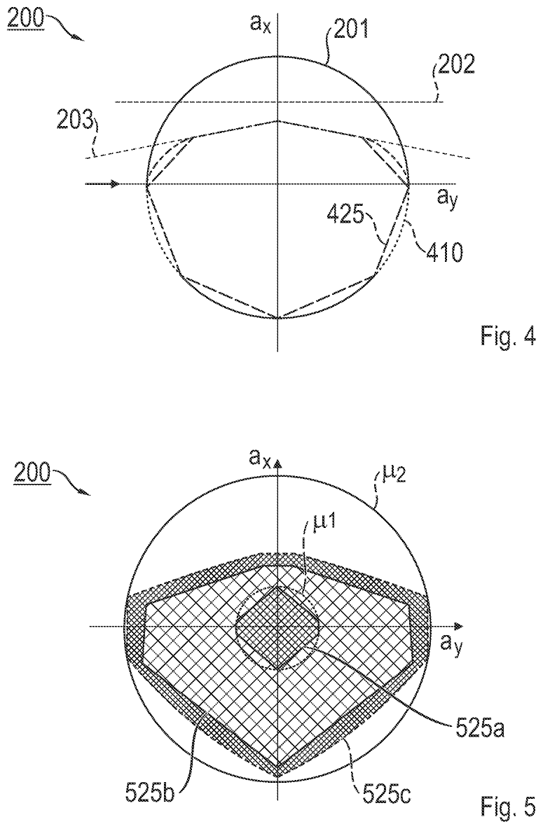

FIG. 4 shows a schematic acceleration diagram 200 for a vehicle, according to an example embodiment. This acceleration diagram 200 is similar to the acceleration diagram of FIG. 2. In this case, of the various relevant limits only the friction circle 201, the drive limits 202, and the slip limits 203 are shown explicitly, as examples. Furthermore, non-linear sections 410 of the limits and a linear approximation 425 of the non-linear sections 410 are indicated.

In acceleration situations and deceleration situations, the limits can be described by straight lines and ellipses. The device, or more precisely the production device of FIG. 1, is designed to calculate the intersections between the lines and the ellipses by means of quadratic equations and to connect the said intersections. For this, a rough estimated value of the friction coefficient μ is required.

FIG. 5 shows a schematic acceleration diagram 200 for a vehicle, according to an example embodiment. The acceleration diagram 200 is similar to the acceleration diagrams in FIGS. 2 and 4. The acceleration diagram 200 shows a first value field 525a, a second value field 525b, and a third value field 525c. In addition, friction circles are indicated, which represent a first estimated value μ₁ of the friction coefficient μ and a second estimated value μ₂ of the friction coefficient μ. The first estimated value μ₁ of the friction coefficient μ corresponds to a cautious or safe estimate of the friction coefficient μ and the second estimated value μ₂ of the friction coefficient μ corresponds to a realistic estimate of the friction coefficient μ. The first value field 525a is located inside the friction circle associated with the first estimated value μ₁. The second value field 525b and the third value field 525c are located inside the friction circle associated with the second estimated value μ₂, which is larger than the friction circle associated with the first estimated value μ₁. The first value field 525a is related to the first limit data set mentioned in connection with FIG. 1 and represents safe limits. The second value field 525b is related to the second limit data set and represents limits on the basis of a conservative estimate of the real physical limits. The third value field 525c is related to the third limit data set and represents real physical limits. These are not known exactly and therefore represent theoretical values. In the second value field 525b these values are estimated as carefully as possible, but not optimistically. When the third value field 525c is used, for example skid regulation systems are used in the event of emergency braking. If a trajectory is no longer possible under the estimated limits of the third value field 525c, then and only then can the trajectory planning exceed the limits.

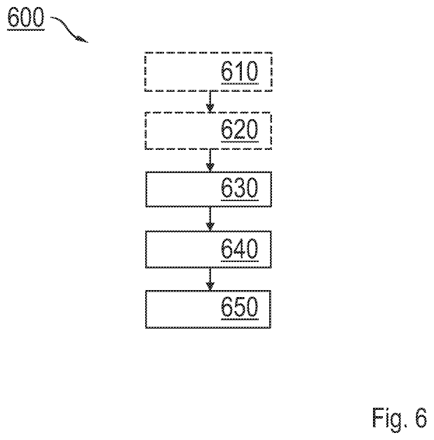

FIG. 6 shows a flow chart of a method 600 for adjustment in accordance with an example embodiment. The method 600 can be carried out in order to adjust a planned trajectory for a vehicle, in particular a vehicle designed for highly automated driving. In this case the method 600 for adjustment can be carried out in connection with the vehicle in FIG. 1 or a similar vehicle. The method 600 can also be carried out using the device from FIG. 1 or a similar device.

In a production step 630 of the adjusting method 600 for adjusting with the use of at least one drive-dynamical characteristic value of the vehicle and an estimated value for a friction coefficient between the vehicle and a road, a plurality of different limit data sets for implementing the planned trajectory are produced. Each limit data set contains limit values for a kinematic driving condition of the vehicle. Thereafter, in a step 640 of selecting from the plurality of different limit data sets, that limit data set which has the lowest limit values is chosen, with which the planned trajectory can be implemented depending on the current trajectory control data. The trajectory control data include current environment data from an environment sensor of the vehicle and/or current position data from a position sensor of the vehicle. Following this in turn, in a step 650 of application the limit data set chosen in the selection step 640 is used to adjust the trajectory. In that way an adjusted trajectory is generated.

According to an example embodiment, the setting method 600 also comprises a step 610 of reading-in and/or a step 620 of estimating. In the reading-in step 610 the at least one drive-dynamical characteristic value, the environment data and/or the position data are read. In the estimation step 620, using the environment data and/or the position data the friction coefficient is estimated. In that way the estimated value for the friction coefficient is generated. The reading-in step 610 and the estimating step 620 can be carried out before or during the production step 630.

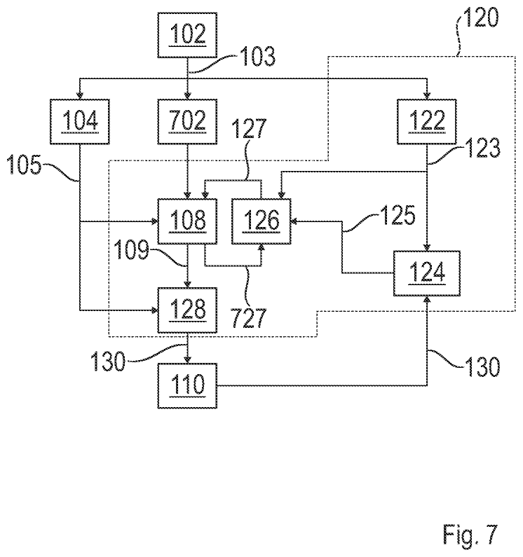

FIG. 7 shows a schematic representation of a device 120 according to an example embodiment. In this case the device 120 corresponds to or is similar to the device of FIG. 1.

The figure shows the at least one environment sensor 102 outside the device 120, the environment data 103, a perception module 702 outside the device 120, the position sensor 104 outside the device 120 for determining the position, the position data 105, the trajectory planning device 108 or trajectory planner as part of the device 120, the trajectory data 109 or target trajectory, the actuator 110 outside the device 120, the estimating device 122 as part of the device 120, the estimated values 123, such as the saddle-horse, mass, upward slope, inclination, etc., the production device 124 as part of the device 120 for producing the limits, the limit data sets 125, the selection device 126 as part of the device 120, the limit data set 127 selected, a safety step 727 or selection criteria, the application device 128 or a trajectory regulator as part of the device 120, and the control signal 130 or control values.

Below, example embodiments and backgrounds and advantages of the said example embodiments are summarized with reference to the figures described above and explained again briefly using other words.

A vehicle 100 has drive-dynamical limits. These limits can be described, for example, in terms of a maximum obtainable transverse acceleration a_{y} and longitudinal acceleration aₓ. The limits are determined by various aspects. As examples, tire and road inclination properties, but also actuator properties such as available drive torques or steering angles or steering torques that can be obtained, can be mentioned. The design of an axle kinematic also plays a part in this. Moreover, longitudinal- and transverse-dynamical limits are coupled with one another by way of the tires. Thus, while driving around a curve at constant speed a higher constant transverse acceleration can be maintained than when accelerating round a curve (key words; traction circle). In vehicles that are highly automated or at least partially autonomously driving, or vehicle with driver assistance systems, a target trajectory is calculated predictively by an algorithm, for example, by means of the trajectory planning device 108. A secondary controller converts this target trajectory into control commands for the in turn lower-level actuators 110, such as the steering system, brakes, drive unit, etc. During this the current position of the vehicle is monitored continuously, and if differences exist between the target and the actual trajectory, then corrective action is taken by the actuators 110. In planning the target trajectory drive-dynamical limits of the vehicle 100 including all relevant part-systems should be taken into account so that the vehicle 1X) with its subordinate trajectory and actuator controls (steering, drive, brakes, etc.) can also implement these target trajectories. In calculating the drive-dynamical limits, much information should be available: for example, road and tire properties, steering and transmission ratios, properties of a drive motor, available torques of a steering actuator, vehicle mass and geometry, and properties of the chassis. The description of the drive-dynamical limits can be depicted in a planning process, for example, in the form of models or simple heuristic characteristics, for example.

The trajectory planning and trajectory control are safety-critical processes that should be validated. The planning of a trajectory should allow for future events and situations, and is therefore in principle subject to some uncertainties, for example, due to uncertain or unknown road properties such as the friction value, but also upward or downward road inclination and the like, uncertain or unknown environmental properties such as side-winds, unforeseeable sudden situation changes, actuator malfunctions or actuator degradation, and the like. When driving round a curve, for example, the steering should assist the transverse acceleration a_{y} by building up a steering torque. If the steering system is degraded, the transverse acceleration a_{y} that can be supported is reduced. If this happens while driving round a curve, a previously drivable trajectory can become a no-longer-drivable trajectory and there is a risk that the vehicle may drift off the curve.

To plan a trajectory safely, such uncertainties should therefore be allowed for in the planning. One strategy is to plan the trajectory with modest drive-dynamical demands, so that even if unfavorable road and environmental conditions occur, and also in the event of actuator degradation, the trajectory will remain drivable. However, this strategy is only suitable to a very limited extent for coping with sudden and therefore unplanned events. For example, if a sudden obstacle arises then it may have to be circumvented with an adjusted or changed trajectory with more severe drive-dynamical demands.

The state of affairs described above can be resolved by virtue of a multi-stage, for example three-stage safety concept in accordance with example embodiments. In this context drive-dynamical limits are used to secure various situations.

For the calculation of the trajectory with safe limits or Safe Constraints, see for example the first value field 525a in FIG. 5:

This is the nominal case for predictable situations. In this case the limits or limit values are approximately in the range ±3 m/s². The calculation takes place under the assumption of errors/uncertainties, such as a degradation of the steering system and thus reduced steering torque and consequently reduced transverse support around curves, lower friction value, etc. Planning under these assumptions is still possible so long as a predictable situation exists, whereas an unpredictable situation can arise, for example, if a child jumps out in front of the vehicle 100. If an error or imponderable occurs, then negative effects can advantageously be prevented since the trajectory has been planned using safe limits.

For the calculation of the trajectory with conservative physical limits, i.e. Conservative Physical Constraints, see for example the second value field 525b in FIG. 5:

If an accident-free/safe trajectory can no longer be implemented with the safe limits because of unforeseen events, such as a child jumping in front of the vehicle 100, it is attempted to render the situation safe with the conservative physical limits. The calculation takes place under the assumption of the current system condition, for example, the current degradation condition, the current friction value, etc. The probability is low that while coping with the unforeseen event that an actuator failure will occur. Thus, it is advantageously possible for many situations with stricter drive-dynamical demands to be negotiated safely.

For the calculation of the trajectory while ignoring the limits, or with real physical limits or Real Physical Constraints, see for example the third value field 525c in FIG. 5:

If an accident-free/safe trajectory can no longer be implemented even with the conservative physical limits, the device 120 is designed to adjust the planned trajectory in such manner that the constraints are ignored. In that way the real physical limits can be used, but the trajectory can no longer be made secure. However, a possible extent of damage can at least be reduced. As an example, one can mention a demand for an emergency braking operation with aₓ=−20 m/s², which would exceed a tire force potential whereby the system intervenes in an ABS regulation. Thus, the full drive-dynamical potential can be used, and the probability of this occurring is minimal thanks to the two previous stages, i.e. the safe limits and the conservative physical limits.

The example embodiments described and illustrated in the figures are chosen only for exemplary purposes. Different example embodiments can be combined with one another completely or in relation to individual features. Moreover, one example embodiment can be supplemented by features of another example embodiment.

Furthermore, process steps according to the invention can be repeated or carried out in a sequence other than that described.

If an example embodiment contains an “and/or” link between a first feature and a second feature, this can be understood to mean than in one version the example embodiment has both the first feature and the second feature, whereas in a different version it has either only the first feature or only the second feature.

### INDEXES

100 Vehicle
102 Environment sensor
103 Environment data
104 Position sensor
105 Position data
106 Storage device
107 Drive-dynamical data
108 Trajectory-planning device
109 Trajectory data
110 Actuator
120 Device
121 Input interface
122 Estimation device
123 Estimated value
124 Production device
125 Limit data set
126 Selection device
127 Limit data set selected
128 Application device
129 Output interface
130 Setting signal
200 Acceleration diagram
aₓ Acceleration along a longitudinal axis of the vehicle
a_{y} Acceleration along a transverse axis of the vehicle
201 Friction circle
202 Drive limit
203 Slip limit
204 Tilt limit
205 ABS limit
206 Brake limit
300 Drive power/speed diagram
301 First graph
302 Second graph
303 Third graph
304 Fourth graph
305 Fifth graph
410 Non-linear section
525 Linear approximation
525a First value field
525b Second value field
525c Third value field
μ₁ First estimated value of the friction coefficient
μ₂ Second estimated value of the friction coefficient
600 Method for adjusting
610 Reading-in step
620 Estimating step
630 Production step
640 Selection step
650 Application step
702 Perception module
727 Safety step

1-10. (canceled)

11. A method (500) for adjusting a planned trajectory for a vehicle (100), the method (600) comprising:
producing (630) a plurality of different limit data sets (125) for implementing a planned trajectory (109) using at least one drive-dynamical characteristic value (107) of the vehicle (100) and an estimated value (123, μ₁, μ₂) for a friction coefficient between the vehicle (100) and a road, wherein each of the plurality of different limit data sets (125) contains limit values for a kinematic driving condition (aₓ, a_{y}) of the vehicle;
selecting (640) a limit data set (127) from the plurality of different limit data sets (125) produced, the limit data set (127) containing minimum limit values with which the planned trajectory (109) can be implemented, wherein the current trajectory control data (103, 105) comprise current environment data (103) from an environment sensor (102) of the vehicle (100) and/or current position data (105) from a position sensor (104) of the vehicle;
calculating the planned trajectory (109) as a function of a current trajectory control data (103, 105) and as a function of the limit data set (127) selected from the plurality of different limit data sets (125) produced; and
adjusting the planned trajectory (109).

12. The method (600) according to claim 11, wherein producing (630) the plurality of different limit data sets (125) is performed using safety factors for scaling the at least one drive-dynamical characteristic value (107) and/or the estimated value (123, μ₁, μ₂) for the friction coefficient, wherein the safety factors are defined at least as a function of an estimated, measured, or otherwise known error magnitude, a stochastic uncertainty, and/or a measured or estimated wear condition of at least one actuator (110) of the vehicle (100), and wherein the limit values for each limit data set (125) are determined using at least one physical model.

13. The method (600) according to claim 11, wherein producing (630) the plurality of different limit data sets (125) comprises:
producing a first limit data set (125) with first limit values using a first estimated value (123, μ₁) for the friction coefficient; and
producing at least a second limit data set (125) with second limit values using a second estimated value (123, μ₂) for the friction coefficient;
wherein physical limit values (125) are based on a third estimated value (123) for the friction coefficient, wherein the second estimated value (123, μ₂) is larger than the first estimated value (123, μ₁) and smaller than the third estimated value, and wherein the second limit values are larger than the first limit values but smaller than the physical limit values.

14. The method (600) according to claim 11, wherein producing (630) each of the plurality of different limit data sets (125) comprises:
using the at least one drive-dynamical characteristic value (107) and the estimated value (123, μ₁, μ₂) for the friction coefficient; and
determining a value field (525a, 525b, 525c) in an acceleration diagram (200) relating to the longitudinal acceleration (aₓ) and the transverse acceleration (a_{y}) of the vehicle (100).

15. The method (600) according to claim 11, comprising:
reading-in the at least one drive-dynamical characteristic value (107), the current environment data (103), and/or the current position data (105).

16. The method (600) according to claim 11, comprising:
estimating the friction coefficient (123, μ₁, μ₂) using the current environment data (103) and/or the current position data (105).

17. A control device (120), configured to carry out the method according to claim 11.

18. Machine-readable storage medium comprising machine-readable code executable by the control device of claim 17.

19. A vehicle (100) comprising a control device (120) configured to carry out the method according to claim 11.
